(19) United States
(12) Patent Application Publication
(10) Pub. No.: US 2013/0278537 A1
(43) Pub. Date: Oct. 24, 2013

(54) TOUCHSCREEN WRITING SYSTEM

(71) Applicants: Mark D. Hansen, Buffalo Grove, IL (US); Yossi Y. Cohen, Laguna Niguel, CA (US); Sanjay Gupta, Lakewood, IL (US)

(72) Inventors: Mark D. Hansen, Buffalo Grove, IL (US); Yossi Y. Cohen, Laguna Niguel, CA (US); Sanjay Gupta, Lakewood, IL (US)

(73) Assignee: Motorola Mobility, Inc., Libertyville, IL (US)

(21) Appl. No.: 13/450,906

(22) Filed: Apr. 19, 2012

(51) Int. Cl. G06F 3/044; G06F 3/041

(52) U.S. Cl. 345/174; 345/173

(57) ABSTRACT

A touchscreen writing system includes a shaft having on-screen circuitry configured to communicate with an electronic display in an on-screen condition, and off-screen circuitry configured to communicate with the electronic display in an off-screen condition. A stylus controller sends signals to a touch-sensitive interface of the electronic display for determining a coarse approximate position for the writing nib. The stylus controller also determines relative fine approximate position coordinates for the writing nib, which are sent to the computing device. A touch-sensitive interface controller provides a starting reference point for fine positioning of the writing nib based on a last coarse approximate position as determined by the on-screen circuitry for the off-screen condition. The stylus controller sends fine positioning information to the touch-sensitive interface and a detector determines whether the writing nib has been engaged on an off-screen writing surface.

### FIELD OF THE DISCLOSURE

The present disclosure relates to inputting information on an electronic device having a touch-sensitive interface via an electronic stylus.

### BACKGROUND

Today's users of mobile wireless communication devices and electronic signage boards that employ touchscreens as displays are required to use at least two writing instruments when the touchscreen interface has a capacitive sensing design, for example. One instrument is for writing on the touchscreen itself (e.g., a stylus), another is for writing off of the touchscreen (e.g., a pen or pencil), specifically on paper type products, such as note pads, composition books, daily planners, and tablets, for example. This dual necessity causes most users to remember to have both writing instruments in their possession during the day so that they are well-equipped for meetings, for example.

Conventionally, electronic writing surfaces or displays have “on-screen” support that captures the marks written on the surface of the electronic device. However, there are use cases where people write on paper and have those writings or notes captured digitally by an electronic device. Currently, solutions exist for either one writing environment or the other. Consequently, there is no solution that will work satisfactorily in both environments at the same time. Therefore, there is a need for an improved touchscreen writing system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates by way of example a block diagram for a stylus operating system.

FIG. 2 illustrates by way of example a block diagram for a computing device system.

FIG. 3 illustrates by way of example a flowchart for a method of on-screen and off-screen digital capture.

FIG. 4 illustrates the ability of a user to transfer from a paper writing surface to a touch-sensitive writing surface using one embodiment of an active stylus.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. Where possible, the same reference number has been used in multiple figures for consistency and clarity.

The apparatus and method components have been represented where appropriate by conventional symbols in the drawings, showing only those specific details that are pertinent to understanding one or more embodiments so as not to obscure the disclosure with details that will be readily apparent to those of ordinary skill in the art having the benefit of the description herein.

### DETAILED DESCRIPTION

A touchscreen writing system that includes a shaft having an on-screen circuitry configured to communicatively and directly engage a primary electronic display in an on-screen condition, and an off-screen circuitry configured to communicatively and indirectly engage the primary electronic display in an off-screen condition. In addition, a writing nib is coupled alternatively to either the on-screen circuitry when the on-screen condition is recognized or coupled to the off-screen circuitry when the off-screen condition is recognized. A stylus controller sends signals to a touch-sensitive interface for determining a coarse approximate position for the writing nib. Likewise, when the fine mode for the writing nib is being used, the controller within the stylus determines relative coordinates for the writing nib, which are then sent to the computing device, for example, a smartphone or a tablet computer. Stylus positioning logic that can reside on a smartphone or tablet computing device, having a touch-sensitive interface, translates relative positioning coordinates to a true absolute position for the stylus as it is engaged with the touch-sensitive interface of the smartphone or tablet computer or other computing device having a touch-sensitive interface. A touch-sensitive interface controller provides a starting reference point for fine positioning of the writing nib based on a last coarse approximate position as determined by the on-screen circuitry for the off-screen condition. The stylus controller sends fine positioning information to the touch-sensitive interface and a detector determines whether the writing nib has been engaged on an inking or non-inking writing surface for the off-screen condition.

Additionally, one or more embodiments may be useful in electronic devices that include touch-sensitive interfaces, but may not be a communication device akin to a mobile wireless communication device. Therefore, the realized benefits of what's being proposed is not specifically limited to mobile wireless communication and can include one or more other electronic devices with touch-sensitive interfaces, for example touchscreens in vehicles, kitchen appliances, classroom presentation boards, restaurant meal ordering displays, retail point of sale displays, or electronic signage displays, for example.

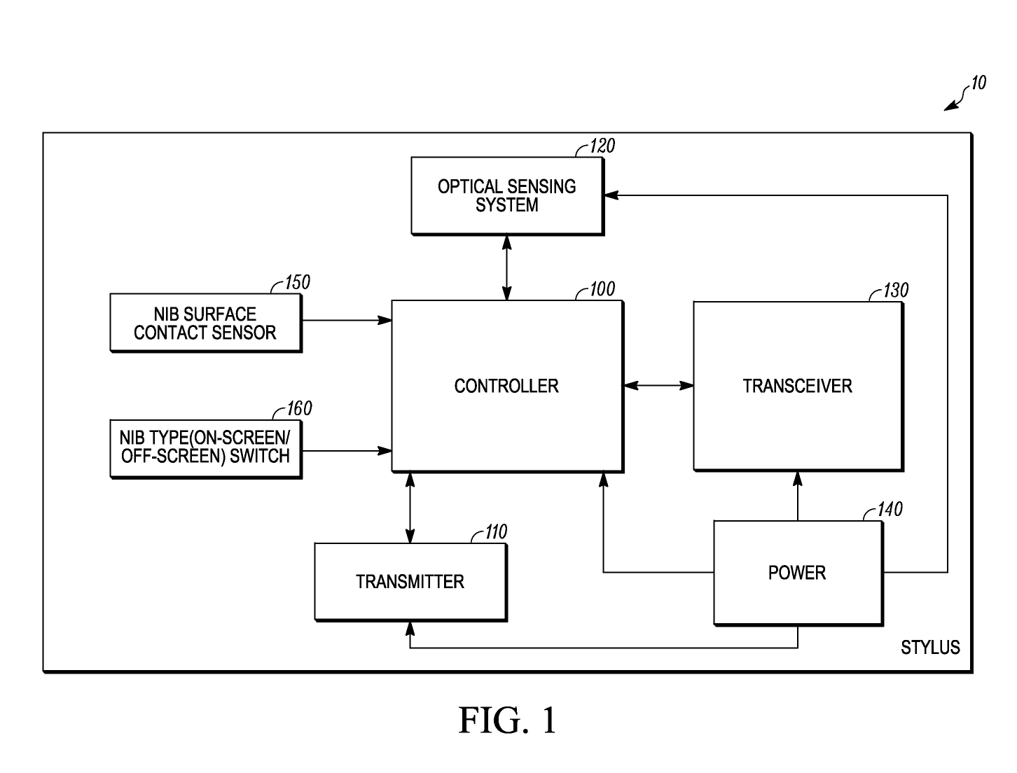

FIG. 1 is an example illustration for showing that an active stylus can include several electronic components to form a stylus system 10. The stylus system 10 can include, for example, a controller 100, a transmitter 110, optical sensing system 120, a transceiver 130, power components 140, a nib surface contact sensor 150, and a nib type switch 160.

The system of FIG. 1 is further described, wherein the controller 100 (also can be referred to as a processor by those ordinarily skilled in the art), includes switch control logic for communicating with other system components. As such, controller 100 can be communicatively coupled, for example, to the transmitter 110. The transmitter 110 can be an electromagnetic transmitter. Alternatively, the transmitter comprises an active capacitive system for triggering a projected capacitance sensor, disposed within a touch-sensitive interface, which can be used in an embodiment comprising a capacitive touch-sensitive interface. The controller 100 can also be, for example, communicatively coupled to an optical sensing system 120, which enables the reception and transmission of optical signals and their attenuation and amplification based on the positioning of the active stylus. Transceiver 130 can also be communicatively coupled to controller 100 for receiving and transmitting communication signals from a communication device that the active stylus interacts with during a writing exercise. Various power components 140 can be employed to provide electrical power to the active stylus including power supplies, near field communication conductors/coils, batteries and solar panels. The power component 140 is also electrically and communicatively coupled to controller 100 to transmit power to controller 100 and to be controlled or regulated by controller 100.

Optical sensing system 120 of FIG. 1 is communicatively and electronically coupled to both power component 140 and the controller 100. The optical sensing system can employ light emitting diodes, for example, to provide positioning reference points for the writing nib when the writing nib is used in an off-screen mode. Accordingly, controller 100 can be configured to use the condition or status of the optical sensor to determine whether an off-screen condition is disabled or enabled for stylus 10. Other optical sensors or tracking technology may be employed as well to sense relative positioning of the writing nib, for example lasers, including Darkfield Laser Tracking for dark field illumination. The optical sensors can also be CMOS or CCD sensors.

Controller 100 communicates with nib surface contact sensor 150 and nib type switch 160. Accordingly, controller 100 is able to determine whether the writing nib has made contact with or is in proximity to a writing surface via the nib surface contact sensor 150. Based on a predetermined distance threshold of the writing nib to the writing surface, controller 100 can be configured to switch stylus positioning estimates from coarse positioning to fine positioning and vice versa. Controller 100 is also able to determine whether the writing nib has been switched or exchanged (for purposes of writing on-screen or off-screen) via the nib type switch 160, which can also be employed as a detector for determining whether the writing nib has been engaged on an off-screen writing surface for the off-screen condition. Controller 100 can be configured to send notification to the computing device, coupled to the touch-sensitive interface, that subsequent positions reflect known inking positions for the stylus 10.

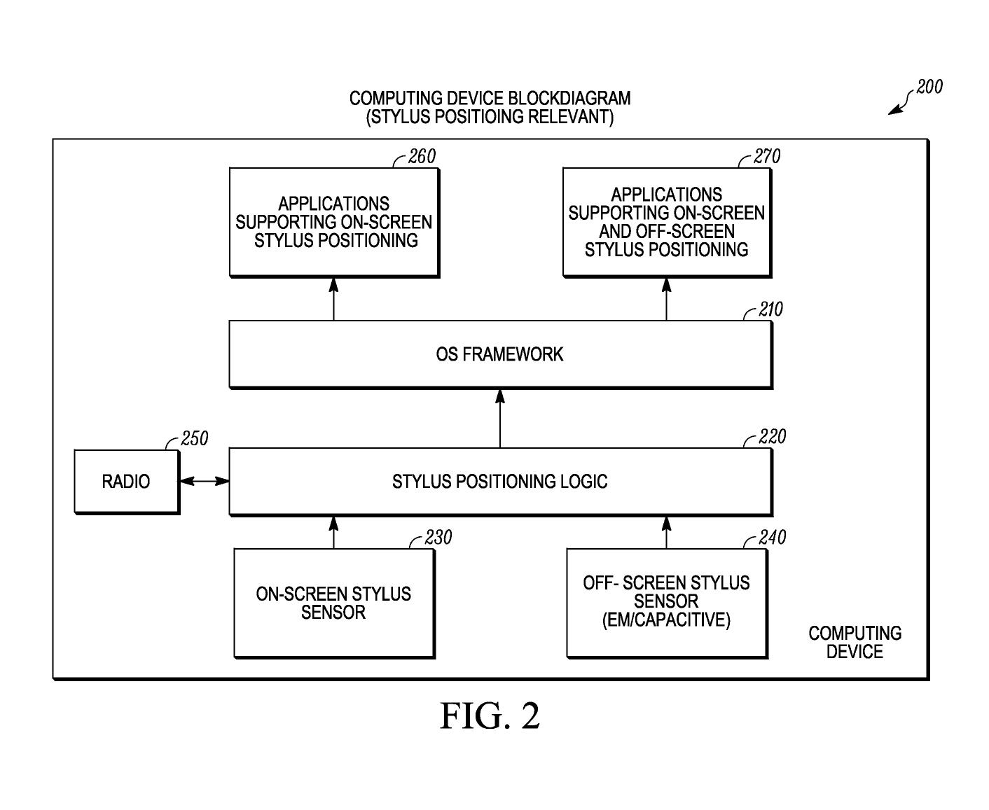

In one embodiment, stylus 10 can include two separate writing nibs on opposing sides of a shaft. One end of stylus 10 includes an inking nib with an optical sensor. The other end of stylus 10 includes an on-screen writing nib. Consequently, circuitry used for the on-screen writing nib, such as capacitive or electro-magnetic circuitry, can be employed for coarse positioning of the inking nib. One technique to accomplish this is to use stylus positioning logic associated with a mobile computing device 200 (shown in FIG. 2) to compensate for the length of the stylus shaft between the two opposing writing nibs. In addition, circuitry configured for use during an on-screen condition can include resistive sensing, thermal sensing, optical, and acoustic sensing components.

FIG. 2 is an example illustration for showing that a mobile computing device 200 such as a tablet computer, a smartphone, a gaming device, and a wearable computing device, for example, includes several electronic components. Mobile computing device 200 includes an operating system (OS) framework 210 for receiving inputs and supporting output applications, for example. One input to OS framework 210 can be stylus positioning logic component 220 that provides positioning information or data subject to a stylus in relation to a touch-sensitive interface. More specifically, stylus positioning logic component 220 has the capability to receive input information relevant to the stylus position from an on-screen stylus sensor 230 and an off-screen stylus sensor 240. The off-screen stylus sensor 240 can receive electromagnetic or capacitive type signals. The stylus positioning logic component 220 can be configured to record multiple stylus positions until receiving notification that the stylus 10 has been lifted from the writing surface.

The stylus positioning logic component 220 also communicates with a transceiver 250 of the computing device 200. The OS framework 210, upon receipt of positioning information from the stylus positioning logic component 220, is able to control discrete stylus applications. For example, one or more applications that support on-screen stylus positioning 260 is under the control of OS framework 210. Likewise, one or more applications that support on-screen and off-screen stylus positioning 270 is under the control of OS framework 210.

Stylus positioning logic component 220 can be programmed to automatically switch the writing nib for an on-screen condition based on detection of a coarse approximate position above the touch-screen interface of computing device 200.

Alternatively, the stylus positioning logic component 220 can reside in controller 100 of the stylus 10. In such an arrangement, the computing device 200 would still determine the coordinates for coarse positioning. However, these coarse positioning coordinates are transmitted to the stylus 10 over a communication link. Subsequently, the stylus controller 100 determines the true, absolute position of the stylus 10 in relation to the computing device 200. This true position can be transmitted back to the computing device 200, over the communication link, as the stylus position.

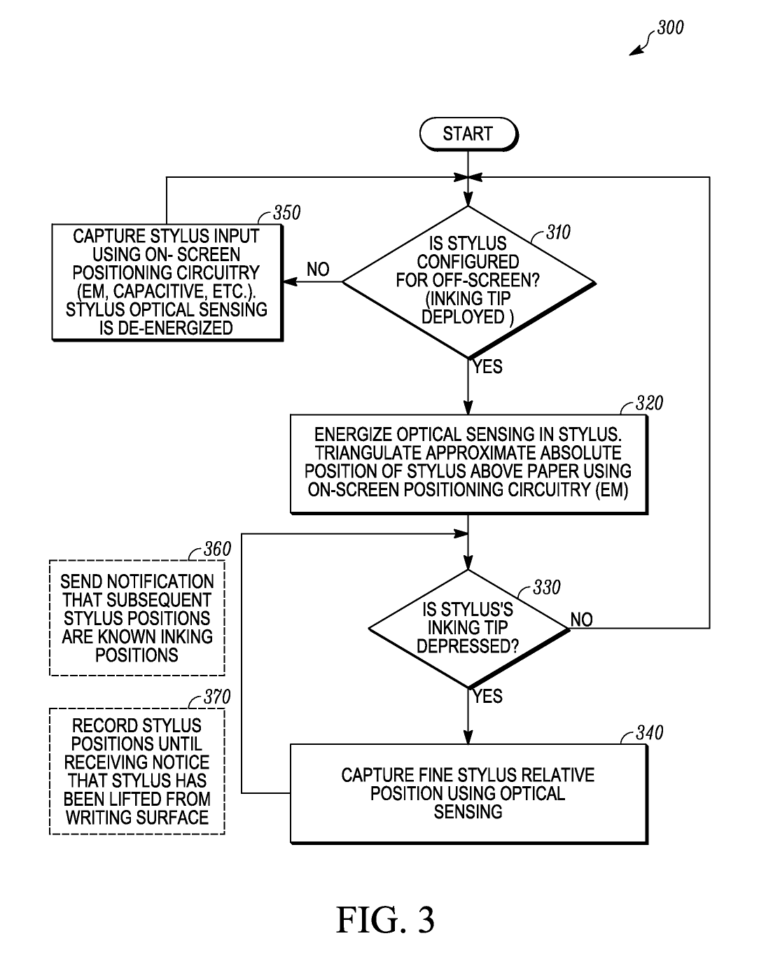

FIG. 3 is an example flowchart 300 for showing the on-screen and off-screen digital capture of handwritten notations. Subsequent to the start of flowchart 300, step 310 determines whether the communicatively coupled stylus is configured for off-screen writing. Step 310 can receive information, for example, that the stylus's inking tip has been deployed, thus providing indication that the stylus is configured for off-screen writing.

An affirmative determination that the stylus is configured for off-screen writing leads to step 320 in which the optical sensing components within the stylus are energized. Therefore, the absolute position of the stylus in an off-screen condition (such as above a sheet of paper) can be triangulated using electro-magnetic circuitry, for example. Accordingly, circuitry can be configured to employ triangulation using electro-magnetic sensing combined with optical sensing.

Step 330 determines whether the stylus's inking tip or writing nib is still depressed or deployed for writing. The optical sensor in the stylus can be impacted upon determination of the status of the inking tip or writing nib.

An affirmative determination that the inking tip or writing nib remains depressed for the stylus enables step 340 to capture a fine stylus relative position using optical sensing, for example. Step 340 continues to capture the fine stylus relative position until the inking tip or writing nib of the stylus is no longer determined to be depressed.

If a negative determination occurs that the inking tip is depressed for the stylus, then flowchart 300 returns to the original determination of step 310 to determine whether the stylus is configured for off-screen writing. A negative determination that the stylus is configured for off-screen writing results in step 350 performing the capture of stylus handwritten input by using on-screen positioning circuitry. The on-screen positioning circuitry can include electro-magnetic circuitry and capacitive circuitry, for example. The optical sensing via one or more optical sensors in the stylus is de-energized when an off-screen condition is detected and the inking tip is not deployed.

Optionally, the above described process can also include a step 360 to send a notification that subsequent stylus positions reflect known inking positions. Optionally, the above described process can include a step 370 to record stylus positions until receiving a notification that the stylus has been lifted from the writing surface whether it is an inking writing surface or a non-inking writing surface.

It is contemplated that the inking tip or writing nib may not be utilized on paper alone, but also on other off-screen writing surfaces or media. That is a user of the touchscreen writing system described herein may want to use the stylus on a hard writing surface, such as a tabletop, for example, thereby capturing handwritten input over a larger surface area than conventional touchscreens associated with the computing device 200 as digital input. Therefore, this arrangement is also contemplated as a useful alternative to simultaneous capture of handwriting on paper and touch-sensitive interfaces.

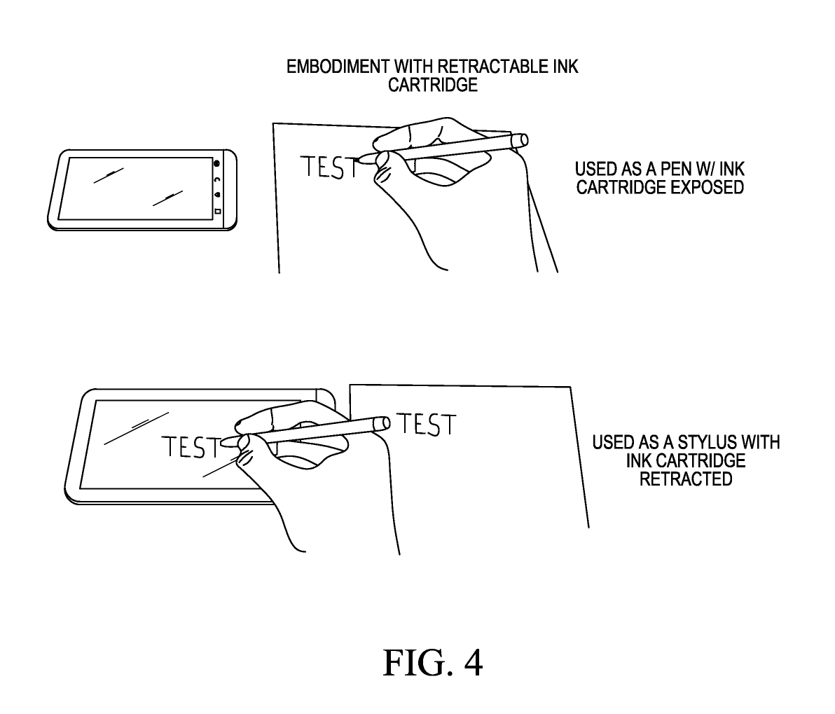

FIG. 4 is an example illustration showing the ability of a user to transfer from one writing surface such as a pad of paper to a second writing surface having a touch-sensitive interface while using a single writing instrument. The active stylus shown is a retractable type embodiment, wherein to write on paper the ballpoint pen tip as a part of an ink cartridge is exposed. The ink cartridges can be multi-colored. To write on or engage with or interact with a touch-sensitive interface on an electronic device, the user retracts the exposed ballpoint pen writing tip (i.e., deployment of a retractable inking end for the stylus) and instead uses the electrically conductive writing tip surrounding the ballpoint pen tip, which includes an opening for the ballpoint pen tip to enter and exit, depending on need to write upon an inking writing surface, and subject to controlling retracting the pen or not. Control for retraction of ballpoint pen tip may be mechanical, optical, or electrical.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A touchscreen writing system, comprising:
a shaft comprising an on-screen circuitry configured to communicatively and directly engage an electronic display, comprising a touch-sensitive interface, in an on-screen condition, and an off-screen circuitry configured to communicatively and indirectly engage the electronic display in an off-screen condition;
a writing nib coupled alternatively to either the on-screen circuitry when the on-screen condition is recognized or coupled to the off-screen circuitry when the off-screen condition is recognized;
a stylus controller configured to send signals to the touch-sensitive interface, of the electronic display, when determining a coarse approximate position for the writing nib;
wherein the stylus controller switches stylus positioning estimates from the coarse approximate position to a fine writing position corresponding to the writing nib;
a touch-sensitive interface controller provides a starting reference point for fine positioning of the writing nib based on a last coarse approximate position as determined by the on-screen circuitry for the off-screen condition;
wherein the stylus controller sends fine positioning information to the touch-sensitive interface; and
a detector for determining whether the writing nib has been engaged on an off-screen writing surface for the off-screen condition.

2. The touchscreen writing system claimed in claim 1, wherein the on-screen circuitry is selected from circuitry for capacitive sensing, resistive sensing, thermal sensing, acoustic, optical, and electro-magnetic (EM) sensing.

3. The touchscreen writing system claimed in claim 1, further comprising circuitry configured to employ triangulation using electro-magnetic sensing combined with optical sensing.

4. The touchscreen writing system claimed in claim 1 further comprising the writing nib comprising a retractable inking end.

5. The touchscreen writing system claimed in claim 1 further comprising at least two writing nibs on opposite distal ends of the touchscreen writing system.

6. The touchscreen writing system claimed in claim 2, wherein the on-screen circuitry further comprises the circuitry for capacitive sensing or the electro-magnetic (EM) sensing while writing in an off-screen condition.

7. The touchscreen writing system claimed in claim 3, wherein the on-screen circuitry includes at least one selected circuitry from a group consisting of capacitive sensing, resistive sensing, thermal sensing, acoustic, optical, and electro-magnetic (EM) sensing and a subset of aforementioned circuitry for writing in an off-screen condition.

8. The touchscreen writing system claimed in claim 1, further comprising an optical LED coupled to the off-screen circuitry for detecting movement when the off-screen condition is recognized.

9. The touchscreen writing system claimed in claim 1, wherein the optical LED is coupled to a CMOS optical sensor that is selectively disabled or enabled during the off-screen condition.

10. The touchscreen writing system claimed in claim 1, wherein position of the writing nib is detected by either capacitive or electromagnetism.

11. The touchscreen writing system claimed in claim 10, wherein the position of the writing nib is triangulated based on phase shift and signal amplitude.

12. The touchscreen writing system claimed in claim 1, wherein the touch-sensitive interface controller enables switching from coarse positioning to fine positioning based on distance threshold of the writing nib to the inking writing surface.

13. The touchscreen writing system claimed in claim 1, wherein the stylus controller enables automatic switching of the writing nib for the on-screen condition based on detection of the coarse approximate position above the touch-sensitive interface.

14. A method employing one or more controllers, comprising:
determining whether a stylus is configured for off-screen writing;
energizing an optical sensor in the stylus, if the stylus is configured for off-screen writing;
approximating absolute position of the stylus, using triangulation, as the stylus is positioned above an off-screen writing surface;
determining whether an inking tip of the stylus is deployed for writing on an ink writing surface;
capturing fine stylus relative positioning utilizing the optical sensor in the stylus when the inking tip of the stylus is deployed; and
capturing a stylus input on an on-screen writing surface when the inking tip is not deployed.

15. The method according to claim 14, further comprising:
de-energizing the optical sensors in the stylus if the inking tip is not deployed.

16. The method according to claim 14, further comprising:
providing an on-screen positioning circuitry comprised of electro-magnetic circuitry for capturing stylus input for on-screen writing.

17. The method according to claim 14, further comprising:
providing an on-screen positioning circuitry comprised of capacitive circuitry for capturing stylus input for on-screen writing.

18. The method according to claim 14, further comprising:
providing an on-screen positioning circuitry comprised of electromagnetic circuitry for capturing stylus input for off-screen writing.

19. The method according to claim 14, further comprising:
sending notification that subsequent stylus positions reflect known inking positions.

20. The method according to claim 14, further comprising:
recording stylus positions until receiving notification that the stylus has been lifted from the ink writing surface.
